(19) United States
(12) Patent Application Publication
(10) Pub. No.: US 2009/0115789 A1
(43) Pub. Date: May 7, 2009

(54) METHODS, SYSTEMS AND APPARATUS FOR MAXIMUM FRAME SIZE

(75) Inventors: Adam D. Dirstine, Rochester, MN (US); Steven L. Halter, Rochester, MN (US); David J. Hutchison, Rochester, MN (US); Pamela A. Wright, Rochester, MN (US); Jeffrey M. Ryan, Byron, MN (US)

Correspondence Address: SCHWEGMAN, LUNDBERG & WOESSNER, P.A., P.O. BOX 2938, MINNEAPOLIS, MN, 55402, US

(73) Assignee: Digi International Inc.

(21) Appl. No.: 11/936,453

(22) Filed: Nov. 7, 2007

(51) Int. Cl. G09G 5/39

(52) U.S. Cl. 345/531

(57) ABSTRACT

Apparatus, methods, and systems are disclosed for capturing video frames. The system determines a maximum memory size available for video capture. The system initiates video capture and acquires a frame. The system then analyzes the incoming frame and determines if the frame is larger than the maximum memory size. If the frame is larger than the maximum memory size and if a quality parameter is greater than zero, the quality parameter is lowered.

### BACKGROUND

Video systems utilize video applications, which may be described as components in software that manipulate video, particularly video acquired from a camera. Video applications require large amounts of memory. Video applications manipulate one or more frames of video, often in a way that requires the entire frame or frames to be in memory all at once. Individual frames can be quite large, so running multiple video applications simultaneously, each holding multiple video frames, results in very high memory usage.

For video capture such as with a camera, it is common that the camera encodes video frames as JPEGs. JPEG compresses video frames based on a configurable property called “quality”. As the quality increases, the image quality increases, the amount of compression goes down and the resultant JPEG gets larger. As the quality is reduced, the image quality goes down, the compression goes up, and the size of the JPEG goes down. In addition to quality, the JPEG size, or compressibility, varies by other factors such as the content of the image. If the content of the image does not compress well, the size of the frame may be quite large. Dependant upon the video source, the resolution, and subject matter being captured, the size of the individual frames may vary. As stated it is common for the individual frames to be quite large; therefore, if multiple video applications are running simultaneously, each holding multiple video frames, the memory usage may be quite high.

The video frames may be provided to an embedded system for the video application to manipulate the video. Embedded systems in many cases have limited memory both volatile and non volatile. Due to costs, intended uses, and other constraints there is a wide spectrum of available processor speeds and memory available for embedded devices. Generally, as cost decreases, both the processor speed and the available memory decrease. As available memory decreases, supporting the video applications may to be difficult due to the memory requirements of video.

### BRIEF DESCRIPTION OF THE DRAWINGS

FIG. 1 is a system diagram of an embodiment of the invention.

FIG. 2 is a flow chart of an embodiment of the invention.

FIG. 3 is a flow chart of an embodiment of the invention.

FIG. 4 is a salvager frame routine 400 according to an embodiment of the invention.

### DETAILED DESCRIPTION

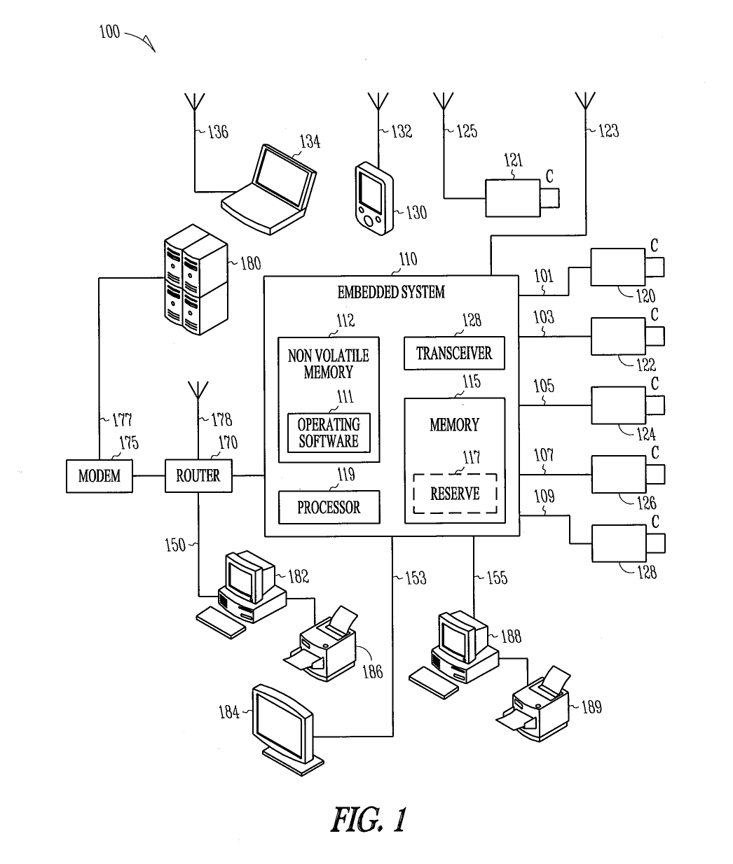

FIG. 1 is a system diagram of an embodiment of the invention. The system 100 incorporates an embedded system 110 and multiple camera inputs. A plurality of cameras may be connected directly to the embedded system 110 such as by a USB (Universal Serial Bus) connector. The cameras may also be connected wirelessly to the embedded system 110. Cameras 120, 122, 124, 126, and 128 may be connected directly to the embedded system 110. These connections 101, 103, 105, 107, and 109 may be USB connections, Firewire connections, or any compatible connection method. A wireless connection may include an antenna 123 connected to the embedded system 110 via a transceiver 128. A camera 121 may be wirelessly connected to the embedded system 110 by antenna 125, by communicating with the embedded system 110 through antenna 123, or through a router 170, which may be wirelessly enabled and have an antenna 178.

Embedded system 110 is enabled to accept from cameras 120, 121, 122, 124, 126, and 128 video in a format such as JPEG. JPEG is a commonly used method of compression for photographic images. The name JPEG stands for Joint Photographic Experts Group, the name of the committee that created the standard. While the specification shall discuss the operation utilizing the JPEG format, other formats of video capture may be utilized with the embodiments of the invention.

Embedded system 110 may be connected to peripherals, a network such as an Ethernet network, or the internet 177 via the router 170 and/or a modem 175. Modem 175 may be connected to a server 180 through the internet 177. The embedded system 110 may be connected to a personal computer 182 via an Ethernet connection 150. Personal computer 182 may also be connected to a printer 186. Embedded system 110 may also be connected to a monitor 184. Monitor 184 may be connected as shown directly to the embedded system 110 through a USB connection 153 or through an Ethernet connection (not shown) via router 170. A personal computer 188 may also be connected directly to embedded system 110 via a USB connection 155. Personal computer 188 may also be connected to a printer 189.

The embedded system 110 may communicate with peripherals via wireless connections. For example, embedded system 110 may communicate to a personal computer 134 having an antenna 136 via antenna 123 connected to transceiver 128 or antenna 178 through router 170. Additionally, a PDA 130 (personal digital assistant) having an antenna 132 may be connected wirelessly to embedded system 110 via antenna 123 or antenna 178. The wireless connections may utilize a Wi-Fi, infrared, or other wireless connection means. Wi-Fi refers to a family of related specifications (the IEEE 802.11 group (Institute of Electrical and Electronics Engineers)), which specify methods and techniques of wireless local area network operation. It is understood that other wireless connection methods may be utilized, provided the wireless connection method provides at least one-way communication either to or from the embedded system 110 to the wireless device.

Embedded system 110 may incorporate memory 115 (such as RAM, random access memory) to receive the direct line inputs from one or more cameras 120, 121, 122, 124, 126, or 128. Embedded system 110 may also incorporate a processor 119 and operating software 111. The operating software 111 may be stored in non-volatile memory 112 and may be stored either in the non-volatile memory 112 or in the memory 115 for execution. Non-volatile memory 112 may be a hard drive, flash memory, or other non-volatile memory. The operating software 111 may specify that a memory reserve 117 be allocated in RAM 115 to receive video inputs from cameras 120, 121, 122, 124, 126, and/or 128. The size of the specified memory reserve 117 may be set by the operating software 111, a user through one of the peripheral devices, or by an API from a camera or other device. An application programming interface (API) is a source code interface that a computer application, operating system, or library provides to support requests for services to be made of it by a computer program. The memory reserve 117 size may not be a fixed size and may vary based upon the operation and requirements of the embedded system 110. The inventors have noted that due to the limitations in memory size, frames acquired by the camera, may not fit within the memory constraints resulting in an error.

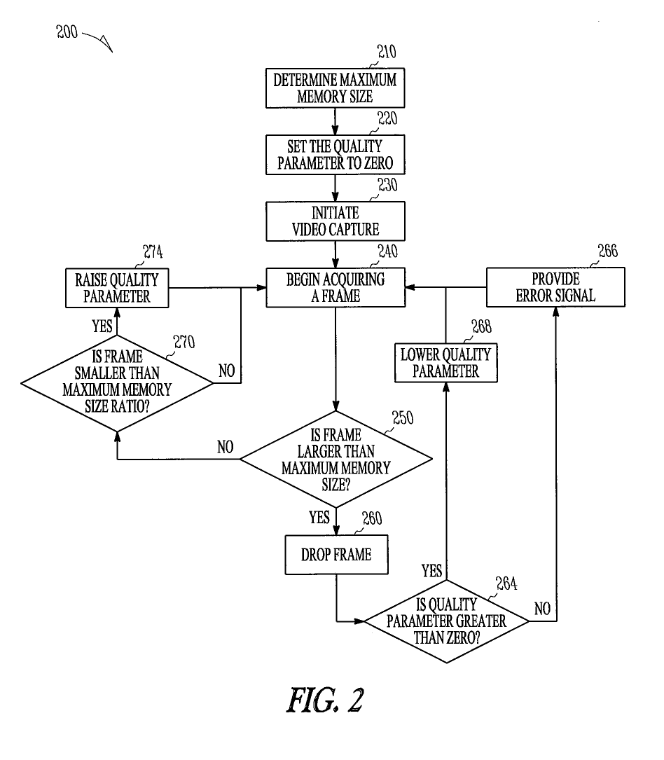

FIG. 2 is a flow chart of an embodiment of the invention. Method 200 may include activity 210 which may be to determine the maximum amount of memory that a frame may take. The maximum memory size may be the full size of the memory reserve 117 of FIG. 1 or a portion thereof. As stated earlier, the memory reserve 117 is a portion of the RAM 115 that is designated as reserved for video capture by the operating software 111.

Activity 220 may be to set the quality parameter to zero. While in this embodiment the quality parameter is set to zero, the quality parameter may be set to any value between 0 and 100. This may be determined by the user, predetermined in the operating software 111, or set by an API of the camera. Quality is a metric that determines the parameters that lead to the overall perception of the image. The value ranges from 0-100, with 0 being the poorest quality picture and 100 being the highest quality picture. Naturally, a low quality picture contains less detail and thus takes less space. In addition, this metric may be used to determine the amount of compression performed on the image (0=maximum compression and data loss, 100=no compression or data loss). For example, if the format used is JPEG, JPEG allows you to make a trade-off between image file size and image quality. JPEG compression divides the image in squares of 8×8 pixels, which are compressed independently. Initially these squares manifest themselves through “hair” artifacts around the edges. Then, as the compression is increased, the squares themselves will become visible. At 100% quality, JPEG is very hard to distinguish from the uncompressed original, which would typically take up 6 times more storage space. At 80% quality, JPEG still looks very good, especially when bearing in mind that that the file size is typically 10 times smaller than the uncompressed original. At 60% quality JPEG, if you look carefully, you will notice some of the JPEG squares and “hair” artifacts around the edges. However, the unmagnified crop would show that the quality is sufficient for websites. It is a great trade-off because the file size is typically 20 times smaller than the uncompressed original. At 10% quality, JPEG shows serious image degradation with very visible 8×8 JPEG squares.

Activity 230 may be to initiate video capture of a camera. The video may be provided in a JPEG format from a camera, for example camera 120 of FIG. 1. Activity 240 may be to begin acquiring a frame from the camera. The frame is acquired by reading it in from the camera into the memory reserve 117 of FIG. 1.

The initial frame data may include a header which indicates the size of the forthcoming frame data. The transport means, such as USB, may also indicate how large the file transfer will be prior to commencing the file transfer. Activity 250 may be to determine if the frame is larger than the maximum memory size. Therefore, prior to the entire frame being acquired, the embedded system 110 may determine if the frame will be larger than the memory allocated as the reserve memory. If no initial data is provided regarding the size of the frame, the frame may be captured until it is determined that it is or may exceed the maximum memory size. Activity 250 may then determine that the frame exceeded the maximum memory size.

If the frame is not too large, the entire frame is acquired into the memory reserve 117. Activity 270 may be to determine if the frame is smaller than the maximum memory size. To prevent the embedded system 110 from repetitively changing the quality settings, it may be possible to determine if the frame size is smaller than a ratio of the maximum memory size. For example, if the frame size is equal to or greater than 80% of the total maximum memory, no changes may be made and activity 240 may be initiated to capture the next frame. If the frame is smaller than 80% of the total maximum memory size, activity 274 may be to raise the quality parameter. The amount the quality parameter is raised may be determined by the user, may be encoded into the camera driver, or may be set by the operating software 111. Once the quality parameter is adjusted, a new frame may be acquired in accordance with activity 240.

If the result of activity 250 is that the frame is larger than the maximum memory size, activity 260 may be to drop that frame. Activity 264 may be to determine if the quality parameter is greater than zero. If the quality parameter is greater than zero, activity 268 may be to lower the quality parameter. As stated earlier, the amount the quality parameter is lowered may be determined by the user, may be encoded into the camera driver, or may be set by the operating software 111. Once the quality parameter is lowered, another frame may be acquired in accordance with activity 240.

If the quality parameter is zero, activity 266 may be to provide an error signal. The error signal may be a software signal and may be provided to one of the peripherals, for example personal computer 182 or over the internet 177 to, for example, a server 180. The error signal may be to provided to a monitor such as monitor 184. The error signal may be stored either in RAM 115, non-volatile memory 112, or externally for future analysis. There are many alternatives that may result from the error signal dependant upon how the designers and users wish to incorporate the error signal into the embedded system 110. After sending the error signal in activity 266, the embedded system 110 may initiate activity 240 to acquire another frame.

The process is followed until embedded system 110 is stopped or no additional frames are provided. As a new frame is acquired, it may be written over the prior captured frame, or it may be written to a new location in memory. Once the frame is captured, the operating software 111 or other software stored in the embedded system 110 may be used to manipulate the frame or pass the frame on to, for example, one of the peripherals.

The method 200 described above was for a single camera. As noted in FIG. 1, embedded system 110 may be connected to one or more cameras. The inputs from these cameras may be provided based on a priority basis, serially or if sufficient memory reserve 117 is available, on a parallel basis.

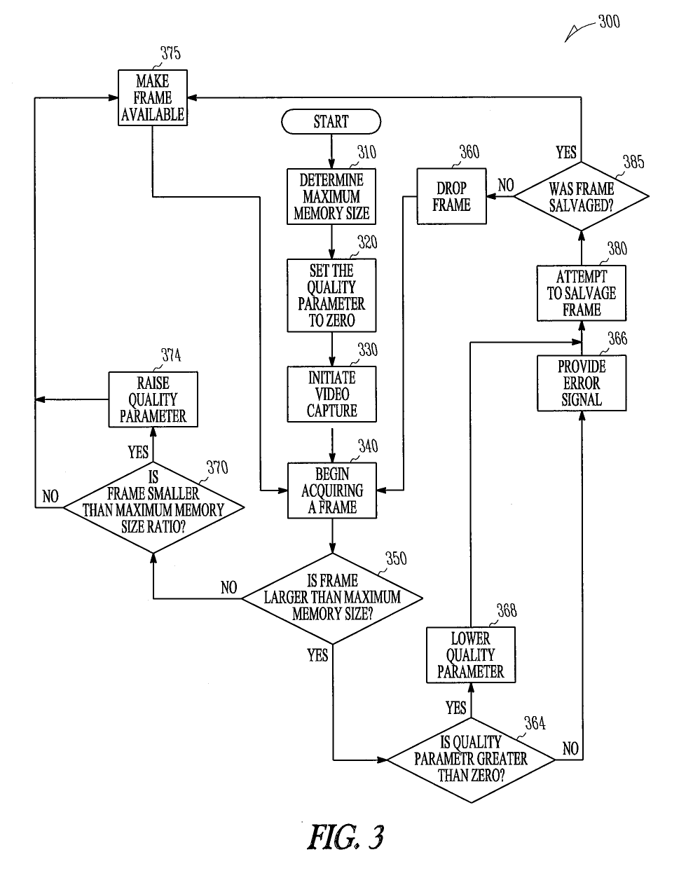

FIG. 3 is a flow chart of an embodiment of the invention. The method 300 is similar to the embodiment of FIG. 2, except that method 300 provides for means to attempt to save the frame that is larger than the maximum memory size. Method 300 may include activity 310 which may be to determine the maximum amount of memory that a frame may take. The maximum memory size may be the full size of the memory reserve 117 of FIG. 1 or a portion thereof. As stated earlier, the memory reserve 117 is a portion of the RAM 115 that is designated as reserved for video capture by the operating software 111.

Activity 320 may be to set the quality parameter to zero. While in this embodiment the quality parameter is set to zero, the quality parameter may be set to any value between 0 and 100. Activity 330 may be to initiate video capture of a camera. The video may be provided in a JPEG format from a camera, for example camera 120 of FIG. 1. Activity 340 may be to begin acquiring a frame from the camera. The frame is acquired by reading it in from the camera into the memory reserve 117 of FIG. 1.

As stated earlier, the initial frame data may include a header which indicates the size of the forthcoming frame data. The transport means, such as USB, may also indicate how large the file transfer will be prior to commencing the file transfer. Activity 350 may be to determine if the frame is larger than the maximum memory size. Therefore, prior to the entire frame being acquired, the embedded system 110 may determine if the frame will be larger than the memory allocated as the reserve memory. If no initial data is provided regarding the size of the frame, the frame may be captured until it is determined that it is or may exceed the maximum memory size. Activity 350 may then determine that the frame exceeded the maximum memory size.

If the frame is not too large, the entire frame is acquired into the memory reserve 117. Activity 370 may be to determine if the frame is smaller than the maximum memory size. To prevent the embedded system 110 from repetitively changing the quality settings, it may be possible to determine if the frame size is smaller than a ratio of the maximum memory size. For example, if the frame size is equal to or greater than 80% of the total maximum memory, no changes may be made and activity 240 may be initiated to capture the next frame. If the frame is smaller than 80% of the total maximum memory size, activity 374 may be to raise the quality parameter. The amount the quality parameter is raised may be determined by the user, may be encoded into the camera driver, or may be set by the operating software 111. Once the quality parameter is adjusted by activity 374, or once it is determined that the quality parameter will not be adjusted by activity 370, activity 375 may make the frame available. Once the frame has been made available, activity 340 will be repeated to begin the process of capturing the next frame.

If the result of activity 350 is that the frame is larger than the maximum memory size, activity 364 may be to determine if the quality parameter is greater than zero. If the quality parameter is greater than zero, activity 368 may be to lower the quality parameter. As stated earlier, the amount the quality parameter is lowered may be determined by the user, may be encoded into the camera driver, or may be set by the operating software 111.

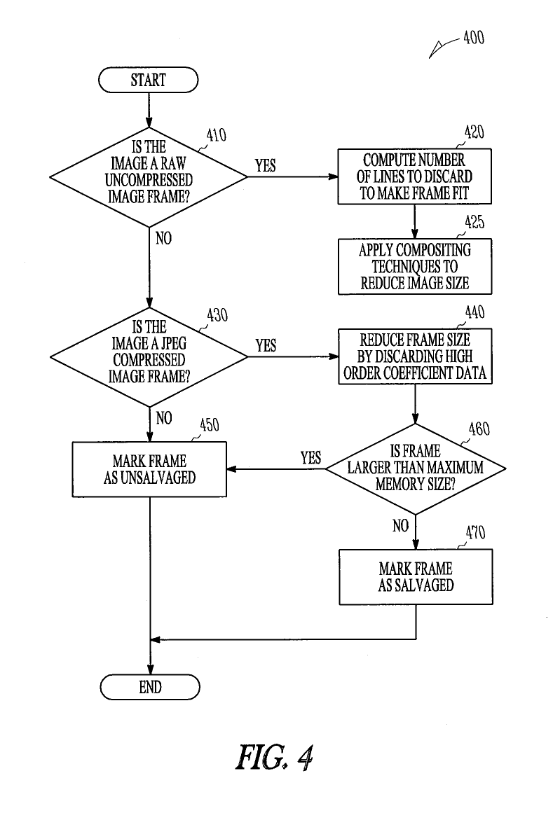

If the quality parameter is zero, activity 366 may be to provide an error signal. The error signal may be a software signal and may be provided to one of the peripherals, for example personal computer 182 or over the internet 177 to, for example, a server 180. The error signal may be provided to a monitor such as monitor 184. The error signal may be stored either in RAM 115, non-volatile memory 112, or externally for future analysis. There are many alternatives that may result from the error signal dependant upon how the designers and users wish to incorporate the error signal into the embedded system 110. After sending the error signal in activity 366 or lowering the quality parameter according to activity 366, activity 380 may be to attempt to salvage the frame. While multiple methods to salvage the frame may exist, FIG. 4 provides one embodiment as suggested by the inventors. Activity 385 may be to determine if the frame was salvaged. If the frame was salvaged, the frame will be made available in accordance with activity 375 and the next frame will be acquired in accordance with frame 340. If the frame was not salvaged, activity 360 is to drop the frame and initiate the acquiring the next frame according to activity 340.

As with method 200 of FIG. 2, the process is followed until embedded system 110 is stopped or no additional frames are provided. As a new frame is acquired, it may be written over the prior captured frame, or it may be written to a new location in memory. Once the frame is captured, the operating software 111 or other software stored in the embedded system 110 may be used to manipulate the frame or pass the frame on to, for example, one of the peripherals.

The method 300 described above was for a single camera. As noted in FIG. 1, embedded system 110 may be connected to one or more cameras. The inputs from these cameras may be provided based on a priority basis, serially or if sufficient memory reserve 117 is available, on a parallel basis.

FIG. 4 is a salvager frame routine 400 according to an embodiment of the invention. A salvage frame routine 300 is one option that may be implemented into activity 380 of FIG. 3. Activity 410 may be to determine if the image is a raw uncompressed image frame. If the image is a raw uncompressed image frame, activity 420 may be to determine the number of lines to discard from the image to make the image fit within the maximum memory size. Activity 420 may have determined that the frame may fit for example by throwing away some percentage of the lines (say every 4th line). Since we know how big the maximum memory size is, and we may know how big the incoming frame is, we can determine how much of the incoming frame we should discard in order to make it fit prior to acquiring another frame. Activity 425 may be to apply compositing software to reduce the image size and clean up the frame. The compositing software may improve our resulting image by, for example, averaging the pixels in two scan lines and saving just a single averaged scan line.

If activity 410 determines the image is not a raw uncompressed image, activity 420 may determine if the image is a JPEG compressed image frame. If the image is JPEG compressed image frame, activity 440 may reduce the frame size by discarding the high order coefficient data. If the image is not a JPEG compressed image frame, activity 450 may mark the frame as un-salvaged. Once activities 425 and activities 440 have been completed activity 460 may review the results and determine if the frames is lager than the maximum memory size. If the frame is not larger than the maximum memory size, activity 470 is to mark the frame as salvaged. If the frame is larger than the maximum memory size, activity 450 may mark the frame as un-salvaged. Once the process has been completed Activity 385 of FIG. 3 will determine if the frame was salvaged.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. The above description and figures illustrate embodiments of the invention to enable those skilled in the art to practice the embodiments of the invention. Thus the following claims are hereby incorporated into the Detailed Description, with each claim standing on its own as a separate embodiment.

What is claimed is:

1. A method comprising:
determining a maximum memory size;
initiating video capture;
acquiring a frame;
comparing the frame to the maximum memory size; and
if the frame is larger than the maximum memory size and if a quality parameter is greater than zero, lowering the quality parameter.

2. The method of claim 1, further comprising:
if the frame is smaller than the maximum memory size, raising the quality parameter.

3. The method of claim 1, further comprising:
if the frame size is smaller than a percentage of the maximum memory size, raising the quality parameter.

4. The method of claim 3, wherein the percentage is approximately eighty percent.

5. The method of claim 1, further comprising if the frame is larger than the maximum memory size, dropping the frame.

6. The method of claim 1, further comprising if the frame is larger than the maximum memory size, applying a salvage frame routine.

7. The method of claim 6, wherein applying the frame reduction routine includes determining a number of scan lines to delete to allow the frame to be less than or equal to the maximum memory size.

8. The method of claim 6, further comprising applying a compositing software.

9. The method of claim 6, further comprising discarding high order coefficient data.

10. A method comprising:
determining a maximum memory size;
setting a quality parameter;
acquiring a frame;
comparing the frame to the maximum memory size;
if the frame is larger than the maximum memory size and the quality parameter is greater than zero, lowering the quality parameter; and
if the frame is larger than the maximum memory size applying a frame salvage routine.

11. The method of claim 10, further comprising:
if the frame is at least a predetermined percentage smaller than the maximum memory size, raising the quality parameter.

12. The method of claim 10, further comprising:
if the frame is larger than the maximum memory size, determining a number of scan lines to delete to allow the frame to be less than or equal to the maximum memory size and reduce the number of scan lines.

13. The method of claim 12, further comprising:
applying a compositing software.

14. An apparatus comprising:
an input to receive an output from at least one camera;
a memory, the memory having a maximum memory size adapted to receive a frame from the at least one camera; and
a processor which receives the frame from the at least one camera, determines if the frame is larger than the maximum memory size, and if the frame is larger than the maximum memory size, lowers a quality parameter.

15. The apparatus of claim 14 wherein, if the frame is smaller than the maximum memory size, the processor raises the quality parameter.

16. The apparatus of claim 14 wherein, if the frame is larger than the maximum memory size, the processor reduces a number of scan lines to allow the frame to be less than or equal to the maximum memory size.

17. The method of claim 16 wherein, if the frame is larger than the maximum memory size, the processor applies a compositing software.

18. The apparatus of claim 14, further comprising a transceiver and an antenna.

19. The apparatus of claim 14, wherein the input includes Universal Serial Bus (USB) Inputs.

20. The apparatus of claim 18, wherein the input includes Universal Serial Bus (USB) Inputs.

21. The apparatus of claim 14, further comprising a connection to send and receive data from a user interface, the user interface for setting the maximum memory size.

22. The apparatus of claim 14, further comprising an output, the output for providing an output based on the frame.

23. A system comprising:
an embedded system having a memory with a maximum memory size and an operating system;
at least one camera connected to the embedded system to provide a frame to the memory, wherein the embedded system when receiving the frame from the at least one camera, determines if the frame is larger than the maximum memory size, and if the frame is larger than the maximum memory size, lowers a quality parameter.

24. The system of claim 23, further comprising a display for displaying the frame.

25. The system of claim 23, further comprising a remote computer to store the frame.
